(19) United States
(12) Patent Application Publication
(10) Pub. No.: US 2011/0018418 A1
(43) Pub. Date: Jan. 27, 2011

(54) LED LIGHTING APPARATUS TO DISSIPATE HEAT BY FANLESS VENTILATION

(75) Inventor: Young Ho Yoo, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignees: Young Ho YOO, Seoul (KR); FAWOO TECHNOLOGY CO., LTD., Bucheon-si, Gyeonggi-do (KR)

(21) Appl. No.: 12/921,355

(22) PCT Filed: Feb. 11, 2009
(86) PCT No.: PCT/KR2009/000632

§ 371 Date: Sep. 7, 2010

(30) Foreign Application Priority Data
Mar. 6, 2008 (KR) 10-2008-0021129
Mar. 17, 2008 (KR) 10-2008-0024364

(51) Int. Cl. H01J 61/52

(52) U.S. Cl. 313/46

(57) ABSTRACT

An LED lighting apparatus dissipating heat by fanless ventilation including a heat radiation housing that has a heat radiation frame provided around the body of the heat radiation housing and spaced apart from the body and also has linear heat radiation fins configured to minimize interference to air flow and to maximize the heat radiation area, thereby expanding the heat radiation area significantly and thus dissipating heat much more effectively through ventilation by natural convection without a blowing fan, and consequently, extending the life span of the LED lighting apparatus and improving its quality. The LED lighting apparatus comprises a light source part including at least one LED and a PCB used to mount the LED; and a heat radiation housing provided at the upper portion thereof with a terminal part, receiving and supporting the light source part and dissipating heat.

### TECHNICAL FIELD

The present invention relates to an LED lighting apparatus that dissipates heat by fanless ventilation, comprising a heat radiation housing that has a heat radiation frame provided around the body of the heat radiation housing and spaced apart from the body and also has linear heat radiation fins configured to minimize interference to air flow and to maximize the heat radiation area, thereby expanding the heat radiation area significantly and thus dissipating heat much more effectively through ventilation by natural convection without a blowing fan, and consequently, extending the life span of the LED lighting apparatus and improving its quality.

### BACKGROUND ART

A light emitting diode (LED) has a smaller size and a longer life span compared with conventional light sources. In addition, because a LED converts electrical energy directly to optical energy, it reduces power consumption and therefore can emit high-intensity light with superior energy efficiency.

Accordingly, various lighting apparatuses employing LED as the light source have been developed. Recently, the use of bulb-type LED lighting apparatus is increasing because bulb-type LED lamps are compatible with the socket of conventional incandescent lamps or the socket of 12 V small halogen lamps.

However, a LED lighting apparatus generates a great amount of heat. Accordingly, if the heat is not dissipated properly, the life span of the LED may be shortened and the illuminance of the LED may be lowered. Accordingly, the above advantages of LED lamps may be attainable only when heat from LEDs is dissipated effectively. The upper limit of temperature for the effective operation of LEDs is around 60° C. , and the performance of the LED lighting apparatus depends on the capability to dissipate heat.

As shown in FIGS. 8 and 9, an LED lighting apparatus 100 according to a related art includes a light source part 110 including a plurality of LEDs 111 mounted on a PCB 113, a heat radiation housing 130 that receives and supports the light source part 110 and performs the function of heat dissipation, and a terminal part 150 provided at the upper portion of the heat radiation housing 130 to apply electric current.

The heat radiation housing 130 has a cylindrical body and heat radiation fins 133 that protrude radially from the cylindrical body in such a manner that the heat radiation fins 133 are alternately aligned while forming gaps 131 between the heat radiation fins 133 in the concave-convex pattern.

According to the related art, in which heat radiation fins 133 protrude radially from the cylindrical body of the heat radiation housing 130, the surface area of the heat radiation housing 130 is enlarged by the fins, and as a result the heat radiation housing 130 can dissipate heat effectively as long as ventilation is good.

However, if the heat radiation housing 130 is installed on the ceiling, ventilation may not be achieved naturally, and then the temperature of the inner circumferential surface 133c serving as a heat absorption part in the cylindrical body of the heat radiation housing 130 is almost as high as the temperature of the outer circumferential surface serving as a heat dissipation part in the cylindrical body of the heat radiation housing 130. In addition, the temperature difference between the lower point 133a, which is adjacent to the PCB 113 to absorb heat, and the upper point 133b, which is far away from the PCB 113 to dissipate heat, and the temperature difference between the outer circumferential surface 133d of the heat radiation fins 133 and the gaps 131 are less than 10% (see FIGS. 8 and 9).

The heat dissipation performance is achieved through heat exchange caused by the temperature difference between the heat absorption part and the heat dissipation part. According to the related art, the temperature difference between the heat absorption part and the heat dissipation part is very small because heated air is stagnant in the gaps 131 between the heat radiation fins 131. Due to the stagnation, the main portion 131a of the outer circumferential surface 133d of the heat radiation fins and the gaps 131 does not perform the heat dissipation function, and only the tip portion of the outer circumferential surface 133d of the heat radiation fin and the gaps 131 between the heat radiation fins performs the heat radiation function but the tip part has an extremely limited area that it is barely exposed to fresh air.

Accordingly, in an environment where ventilation is poor, an effective heat exchange area, which actually performs the heat dissipation function, may not be expanded even if the surface area is enlarged by the heat radiation fins 131.

FIG. 10 shows an LED lighting apparatus 101 according to another related art, in which heat radiation fins 133 protrude outward from the outer circumferential surface of the heat radiation housing 130. In this case, however, part of the lateral surface of the heat radiation fin 133 is integrated with the body of the heat radiation housing 130, and the heat radiation fins 133 are arranged densely. As these features hinder ventilation, the surface area of the heat radiation fins 133 cannot serve as an effective heat exchange area.

In the above structure, if the interval between the heat radiation fins 133 is widened for the purpose of ventilation, the heat radiation area becomes insufficient, and as a result the heat dissipation performance goes down.

In other words, according to the related art, if air is stagnant in windless environment, heat cannot dissipate in the gaps 131 between the heat radiation fins 133 and the inner circumferential surface of the heat radiation housing 130, and the effective heat exchange area is limited to the outer circumferential surface of the heat radiation fins 133 and the portion adjacent to the outer circumferential surface, and consequently, heat dissipation efficiency is very low. Accordingly, the temperature of the PCB 113 may be raised up to 53° C. higher than room temperature.

In order to solve this problem, a blowing fan should be installed to circulate air by force. In this case, the fan may increase the cost of manufacturing and generate noises. In addition, because the life span of the blowing fan is far shorter than that of LEDs, it may diminish the advantage of the LED lighting apparatus in its long life span.

### DISCLOSURE

### Technical Problem

The present invention has been conceived to solve the above problems occurring in the prior arts, and the object of the present invention is to provide an LED lighting apparatus that dissipates heat by fanless ventilation, comprising a heat radiation housing that has a heat radiation frame provided around the body of the heat radiation housing and spaced apart from the body and also has linear heat radiation fins configured to minimize interference to air flow and to maximize the heat radiation area, thereby expanding the heat radiation area significantly and enabling the heat radiation area to dissipate heat much more effectively through ventilation by natural convection without a blowing fan, and consequently, extending the life span of the LED lighting apparatus and improving its quality.

### Technical Solution

In order to accomplish the object of the present invention, an LED lighting apparatus that dissipates heat by fanless ventilation is provided. The LED lighting apparatus comprises a light source part including at least one LED and a PCB used to mount the LED; and a heat radiation housing provided at the upper portion thereof with a terminal part, receiving and supporting the light source part and dissipating heat, wherein the heat radiation housing includes a light source installation part provided at the lower portion of the heat radiation housing to install the light source part, a body formed above the light source installation part and receiving a power driver therein, a ring-type heat radiation frame spaced apart from the outer circumferential surface of the body, and a plurality of linear heat radiation fins connecting the ring-type heat radiation frame to the body and spaced apart from each other at a predetermined interval to dissipate heat.

According to the embodiment of the present invention, the linear heat radiation fins are configured in the form of a bridge to minimize interference to air flow and alternately aligned with each other in a radial direction at a predetermined interval with size difference in either height or curvature radius thereof.

According to the embodiment of the present invention, the linear heat radiation fins include ribs in contact with the outer circumferential surface of the body to expand the heat radiation area.

According to the embodiment of the present invention, the heat radiation frame has a wide lower portion and a narrow upper portion to accelerate natural convection.

According to the embodiment of the present invention, the body, the heat radiation frame, and the linear heat radiation fins of the heat radiation housing are molded in one body.

### Advantageous Effects

As described above, according to the present invention, because the LED lighting apparatus dissipating heat by fanless ventilation includes a heat radiation housing that has a heat radiation frame provided around the body of the heat radiation housing and spaced apart from the body and also has linear heat radiation fins configured to minimize interference to air flow and to maximize the heat radiation area, the LED lighting apparatus has a significantly expanded heat radiation area and thus can dissipate heat much more effectively through ventilation by natural convection without a blowing fan, and consequently, and this extends the life span of the LED lighting apparatus and improves its quality.

### DESCRIPTION OF DRAWINGS

FIG. 1 is a perspective view showing one embodiment of the present invention;

FIG. 2 is a bottom perspective view showing one embodiment of the present invention;

FIG. 3 is a longitudinal sectional view of FIG. 1;

FIG. 4 is a plan view of FIG. 1;

FIG. 5 is a bottom view of FIG. 1;

FIG. 6 is a perspective view showing another embodiment of the present invention;

FIG. 7 is a perspective view showing embodiments of the present invention;

FIG. 8 is a view showing one example of the related art;

FIG. 9 is a bottom view of FIG. 8; and

FIG. 10 is a view showing another example of the related art.

### BEST MODE

### Mode for Invention

Hereinafter, the LED lighting apparatus dissipating heat by fanless ventilation according to one embodiment of the present invention will be described in more detail with reference to the accompanying drawings.

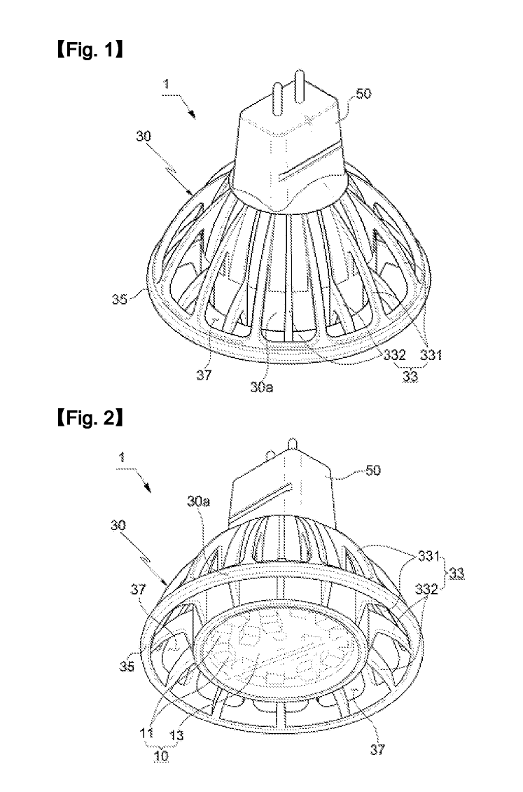

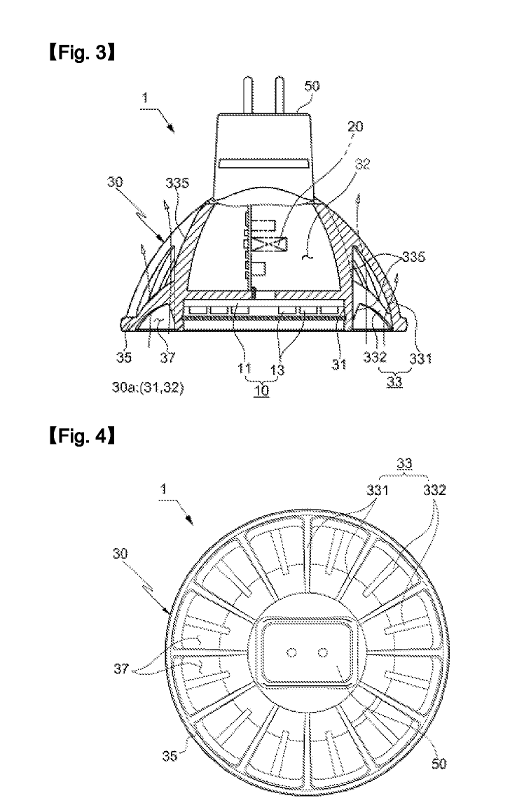

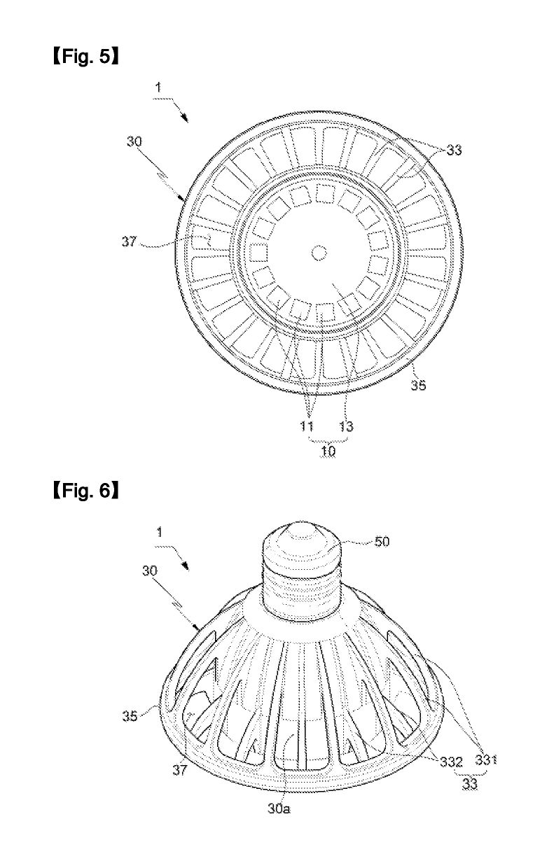

FIG. 1 is a perspective view showing the structure of the LED lighting apparatus 1 according to one embodiment of the present invention, and FIG. 2 is a bottom perspective view of FIG. 1, FIG. 3 is a longitudinal sectional view of FIG. 1, FIG. 4 is a plan view of FIG. 1, and FIG. 5 is a bottom view of FIG. 1.

As shown in FIGS. 1 to 5, the LED lighting apparatus 1 includes a light source part 10 including at least one LED 11 and a PCB 13 used to mount the LED and a heat radiation housing 30 provided at the upper portion thereof with a terminal part 50, in which the heat radiation housing 30 receives and supports the light source part 10 and performs the function of heat dissipation. The heat radiation housing 30 includes a body 30a in which a light source installation part 31 is provided at the lower portion of the body 30a for the light source part 10 and a power driver 20 is provided above the light source installation part 31 in the internal cavity of the body 30a, a ring-type heat radiation frame 35 spaced apart from the outer circumferential surface of the body 30a, and a plurality of linear heat radiation fins 33 for heat dissipation, which are spaced apart from each other at a predetermined interval and connect the ring-type heat radiation frame 35 to the body 30.

According to the above structure, an air passage 37 is formed horizontally between the body 30a and the heat radiation frame 35 constituting the heat radiation housing 30 and also vertically between the body 30a and the linear heat radiation fins 33.

According to one embodiment of the present invention, the linear heat radiation fins 33 are prepared in the form of a bridge to minimize interference to air flow and maximize the heat radiation area. In addition, the linear radiation fins 33 are alternately aligned with each other at a predetermined interval with size difference in either height or curvature radius thereof.

In this regard, the linear heat radiation fins 33 include large-size fins 331 extending from the upper portion of the body 33 to the upper end portion of the heat radiation frame 35 and small-size fins 332 connected to the inner circumferential surface of the heat radiation frame 35 below the middle portion of the body 30a. In addition, preferably, the linear heat radiation fins 33 are alternately aligned with each other at a predetermined interval.

Since the linear heat radiation fins 33 are alternately aligned with each other in different size, ventilation efficiency can be maximized by finding the optimal number of linear heat radiation fins 33.

In addition, the linear heat radiation fins 33 include ribs 335 in contact with the outer circumferential surface of the body 30a for expanding the heat absorption area, and the ribs 335 have an arch shape directed downward from the body 30a.

Preferably, the heat radiation frame 35 has a wide lower portion and a narrow upper portion to accelerate natural convection.

Preferably, the body 30a, the heat radiation frame 35, and the linear heat radiation fins 33 of the heat radiation housing 30 are molded in one body.

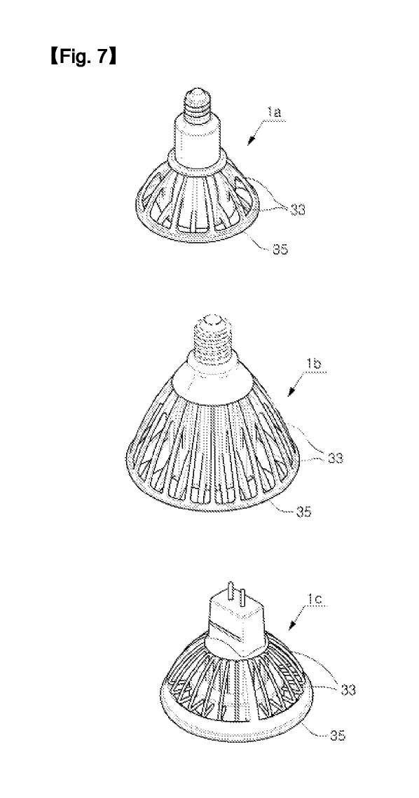

Meanwhile, the terminal part 50 can be prepared in the form of a pin used for a halogen lamp as shown in several drawings including FIG. 1, or in the form of a screw used for a bulb as shown in FIG. 6, so that the terminal part 50 is compatible with sockets for halogen lamps or bulbs.

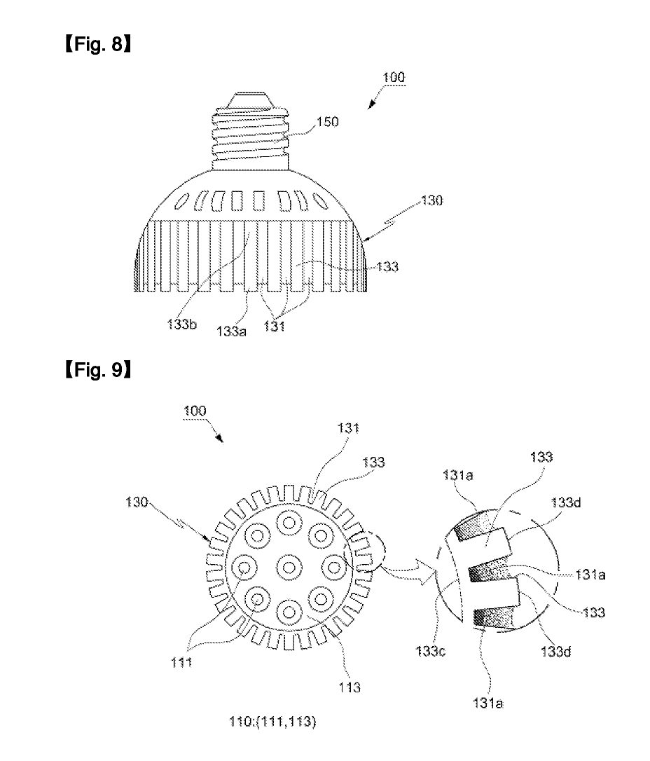

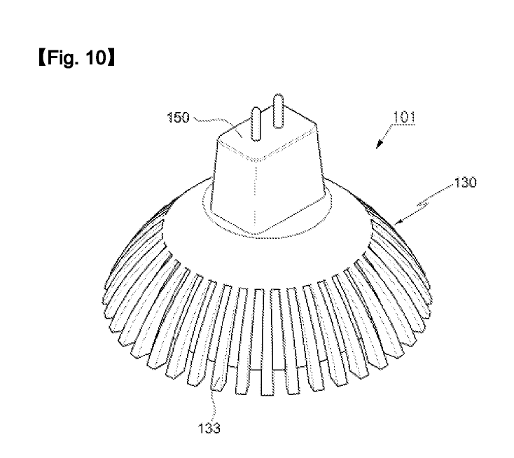

As shown in FIG. 7, the linear heat radiation fins 33 and the heat radiation housing 30 of the present invention may have various configurations. For example, the linear heat radiation fins 33 may have the same shape regardless of size thereof (see 1a of FIG. 7), may be densely provided as the size of the linear heat radiation fins 33 is enlarged in accord with high power capacity (see 1b of FIG. 7), or may be prepared using wires (see 1c of FIG. 7).

Hereinafter, the operation of the LED lighting apparatus 1 according to the present invention will be described.

The heat radiation housing 30 according to the present invention includes a heat radiation frame 35 spaced apart from the outer circumferential surface of the body 30a, and linear heat radiation fins 33 prepared in the form of a bridge suspended in the air to connect the body 30a with the heat radiation frame 35 and to dissipate heat. Accordingly, the heat radiation area is enlarged remarkably and interference to the air flow is minimized, and as a result, the whole outer surface of the heat radiation housing 30 is subject to ventilation by natural convection.

Heat generated from the light source part 10 in the heat radiation housing 30 is dissipated from the light source installation part 31, which serves as a heat absorption part, through the outer circumferential surface of the body 30a, the linear heat radiation fins 33, and the heat radiation frame 35. Since an air passage 37 is formed vertically and horizontally around the body 30a of the heat radiation housing 30, the air heated through heat exchange expands and moves up from the outer circumferential surface of the heat radiation housing 30, and fresh air at room temperature flows into that place. This is called heat radiation and convection.

Accordingly, heated air is not stagnant between the linear heat radiation fins 33, and newly introduced air at room temperature exchanges heat with the outer circumferential surface of the heat radiation housing 30 and then moves upward. As this natural convection, radiation, and ventilation is continued, the entire outer circumferential surface serves as an effective heat exchange area, and heat is dissipated quickly.

In this case, due to the rib 335 connecting each linear heat radiation fin 33 to the body 30a, a very large heat absorption area can be formed for effective heat dissipation. In addition, because large-size fins 331 and small-size fins of different height and curvature radius are aligned alternately with each other, the air passage 37 is maximized and therefore ascending air can flow more effectively.

If the ring-type heat radiation frame 35 provided around the body 30a has a predetermined height, the frame 35 may serve as a suction pipe that accelerates the ascending of air and heat radiation.

As described above, the present invention can be adapted to a large-size LED lamp as well as a small-size one mounted on the socket of a 12V halogen lamp or a bulb.

In addition, the temperature of the heat radiation housing 30 according to the present invention is lowered by 5° C. or more compared with conventional heat radiation housings under the same condition.

In this case, the PCB 13 maintains temperature about 16° C. higher than room temperature. This represents that the heat dissipation performance has been improved remarkably compared with the related art (see FIG. 10) having heat radiation fins protruding radially in which the temperature of the PCB is 53° C. higher than room temperature.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

### INDUSTRIAL APPLICABILITY

The LED lighting apparatus dissipating heat by fanless ventilation according to the present invention enables natural convection, heat radiation, and ventilation, thereby improving heat dissipation performance remarkably and, consequently, extending the life span and improving the quality of the LED lighting apparatus.

1. An LED lighting apparatus dissipating heat by fanless ventilation comprising:
a light source part including at least one LED and a PCB used to mount the LED; and
a heat radiation housing provided at the upper portion thereof with a terminal part, receiving and supporting the light source part and dissipating heat,
wherein the heat radiation housing includes:
a light source installation part provided at the lower portion of the heat radiation housing to install the light source part,
a body formed above the light source installation part and receiving a power driver therein,
a ring-type heat radiation frame spaced apart from the outer circumferential surface of the body, and
a plurality of linear heat radiation fins connecting the ring-type heat radiation frame to the body and spaced apart from each other at a predetermined interval to dissipate heat.

2. The LED lighting apparatus of claim 1,
wherein the linear heat radiation fins are configured in the form of a bridge to minimize interference to air flow and alternately aligned with each other in a radial direction at a predetermined interval with size difference in either height or curvature radius thereof.

3. The LED lighting apparatus of claim 1,
wherein the linear heat radiation fins include ribs making contact with the outer circumferential surface of the body to expand the heat radiation area.

4. The LED lighting apparatus of claim 1,
wherein the heat radiation frame has a wide lower portion and a narrow upper portion to accelerate natural convection.

5. (canceled)

6. The LED lighting apparatus of claim 2,
wherein the linear heat radiation fins include ribs making contact with the outer circumferential surface of the body to expand the heat radiation area.
